(19) United States
(12) Patent Application Publication
(10) Pub. No.: US 2009/0172956 A1
(43) Pub. Date: Jul. 9, 2009

(54) Flexible Chain Saw for Cutting Tree Limbs

(76) Inventor: Howard S. Cheng, Chicago, IL (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/970,020

(22) Filed: Jan. 7, 2008

(51) Int. Cl. B23D 57/02; B26B 9/02; B26B 27/00

(52) U.S. Cl. 30/381; 30/355; 30/296.1

(57) ABSTRACT

A flexible tree cutting saw is operable from ground level for cutting limbs from a tree. The flexible saw includes a flexible cutting chain, about two to three feet in length, with a rope attached to either end and handles attached to the ends of the ropes. A telescoping device with a hook at its top end is used to place the saw over the tree limb with the flexible cutting chain on the tree limb, and the hook is designed to effectively grab the raised handle and lower it towards the user. The user grabs the handle and applies downward pressure and a back and forth motion to saw the limb. The flexible tree cutting saw use a jeweler's style chain with a plurality of substantially planar cutting segments, preferably made from stamped sheet steel, which are either linked together directly or linked together using oval chain links. The cutting segments have two cutting edges and preferably have teeth facing in one direction for a majority of the cutting span of the cutting chain. The planar cutting segments are mounted or linked in the chain so that the cutting edges of one segment are substantially perpendicular in orientation with respect to the cutting edges of the adjacent planar cutting segments, when the chain hangs naturally.

### FIELD OF THE INVENTION

The invention relates primarily to manual chain saws for trimming limbs from trees.

### BACKGROUND OF THE INVENTION

The saw of this invention may be used for other purposes, but it is particularly useful when used for trimming tree limbs. Trimming limbs from standing trees is often difficult, especially when the limbs are far above ground so they cannot be conveniently reached by a person standing on the ground. One way to approach this problem is to use what is sometimes referred to as a flexible tree saw or manual chain saw. Generally speaking, these flexible tree saws include a flexible chain saw blade about two to three feet long, with rope connected to either end of the chain and handles attached to the ends of the rope. The user positions the flexible chain saw blade over the tree limb, sometimes using a long pole and hook. The user then manipulates the rope so that it hangs down within reach of the user. With the saw in place, the user grasps the handles at either end of the rope and saws through the limb by applying downward pressure against the limb and pulling the flexible chain saw blade back and forth to cut the limb. Examples of such prior art tree cutting chain saws are shown in prior art U.S. Pat. No. 3,999,294 to Shoben; U.S. Pat. No. 4,218,820 to Cleva; U.S. Pat. No. 4,242,796 to Barausch et al.; U.S. Pat. No. 4,344,229 to Johnson; U.S. Pat. No. 5,092,047 to Hinkley; and U.S. Pat. No. 5,131,150 to Muehling. The flexible chain saws used in these prior art references are the same or similar to those used in conventional power driven chain saws. For example, all of the chains in the above referenced prior art have a series of individual cutting blade segments that are pivotally connected with connecting links, for example, using rivets or the like to allow bending of the saw chain along an intended bending plane. The cutting blade segments are typically about ¾″ to 1″ long and made of machined steel with sharpened cutting edges. While such one-dimensional pivotal connections are sturdy, they do not allow the cutting blade segments to rotate axially or to bend perpendicularly with respect to the intended bending plane of the flexible chain saw. Most of the flexible chain saw blades in prior art tree cutting saws seem to be derivatives or improved versions of chain saw blades for power-driven chain saws.

The cutting blade segments in many of the prior art flexible chain saws face downward only (as with a conventional power driven chain saw blade), sometimes in alternating directions so that cutting is achieved in both directions. In these systems, orientation of the saw on the limb can be difficult. Also, there can be problems with binding as the saw cuts through the limb. Some prior art chains include cutting blades on both the top and the bottom of the chain in an attempt to alleviate alignment issues. Others have attempted to addressed alignment issues in different ways. In order to avoid binding problems, some flexible saws have cutting blade segments with teeth extending laterally outward from the cutting blade segments in order to provide slightly wider cutting kerfs so that the blade can pass through the limb more easily as it cuts.

### SUMMARY OF THE INVENTION

The invention is a flexible tree cutting saw that uses a jeweler's style chain, for example a rolo style chain, with stamped cutting segments. In the preferred embodiment, the stamped cutting segments are about 3/16″ and connecting links if used are about ⅛″. In a first aspect of the invention, the flexible chain saw blade has a plurality of substantially planar cutting segments each having a first cutting edge on one side of the planar segment and a second cutting edge on the other side of the planar cutting segment. The planar cutting segments are connected to the chain so that each alternative segment is oriented substantially perpendicular with respect to adjacent cutting segments, as the chain hangs naturally. Preferably, each of the cutting edges includes forward facing teeth so that the flexible chain saw cuts in only one direction, at least over a majority of its cutting length (e.g. about two feet). The flexible cutting chain has elongated ropes and preferably handles connected to either end. The resulting flexible chain saw has been found effectively cutting tree limbs, without binding problems and alignment problems, and is economical to manufacture.

The cutting segments are preferably made from stamped sheet steel without sharpened cutting edges. In one embodiment, the cutting segments are joined together in perpendicular pairs with at least one oval link connecting the pairs. In another embodiment, an oval link is used to connect between individual segments. In another embodiment, each stamped cutting segment has a circular opening and an enlarged oval opening along its center line which are used to directly link the segments together. For assembly, the stamped segment requires a slot leading to the oval opening through which the circular opening for an adjacent segment is passed through to connect the segments. The slot is later soldered or welded in order to ensure appropriate strength.

In one embodiment, the cutting edges have one forwardly facing tooth, and in other embodiments there are three forwardly facing teeth. The stampings have substantially rounded surfaces in the other direction. This configuration with four perpendicularly disposed cutting tooth cutting edges have been found to be particularly effective in cutting tree limbs. There is little or no need to align the flexible chain saw in order for a significant number of cutting edges to be in active contact with the tree limb. Moreover, aligning the teeth in one direction, while at the same time providing substantially rounded surfaces in the other direction, allows the chain to slide rearward easily in the case of binding during the forward stroke.

Along a relatively small portion towards an end of the flexible chain saw blade, it is preferred that the direction of the teeth on the cutting edges alternate in order to allow cutting in a back and forth motion. This is particularly useful for finishing off the cut.

In another aspect of the invention, a tool is provided for placing a flexible tree cutting saw in place over a raised tree limb. The tool comprises a telescoping pole with a radially extending hook mounted at or near the top of the pole. As the hook extend radially outward from the top of the pole, the hook extends angularly downward when the pole is held vertically to form a first section of the hook, and then bends upward to form a second section of the hook, and finally bends slightly downward again in order to form a third distal section of the hook. The cradle that is formed between the first angularly downward extending section and the second upwardly extending section is used to hold and lift the chain saw in place over the limb. Once the user has placed the flexible chain saw blade over the limb, the distal section of the hook, which extends slightly downward, is used to grab one of the handles and pull the handle towards the user as the pole is lowered. The user then grasps both handles, one in each hand, and proceeds to cut the limb by applying downward pressure on the handles and proceeding with a back and forth sawing motion. In some cases, the limb may not fall immediately even though the cut has been substantially through the entire limb and the limb may even sag or hang from the tree. In these cases, the user may find it desirable to place the end portion of the flexible chain saw which has teeth in alternating directions over the last bit of tree limb that needs to be cut and apply short back and forth motions to cut in both directions.

These features and benefits of the present invention will become apparent from the following drawings and description thereof.

### BRIEF DESCRIPTION OF THE DRAWINGS

FIG. 1 is a schematic drawing illustrating a flexible chain saw being placed over a tree limb with a telescoping tool in accordance with the preferred embodiment of the invention.

FIG. 2 is a schematic illustration showing a user cutting a tree limb using a flexible chain saw in accordance with the invention.

FIG. 3 is a side elevational view of the telescoping tool shown in FIG. 1 for placing the flexible chain saw over the limb of a tree.

FIG. 4 is a detailed view of a portion of the flexible cutting chain used in accordance with a first embodiment of the invention.

FIG. 5 is a view taken along line 5-5 in FIG. 4.

FIG. 6 is a view showing a portion of a flexible cutting chain in accordance with a second embodiment of the invention.

FIG. 7 is a view of a flexible cutting chain in accordance with a third embodiment of the invention.

### DETAILED DESCRIPTION OF THE INVENTION

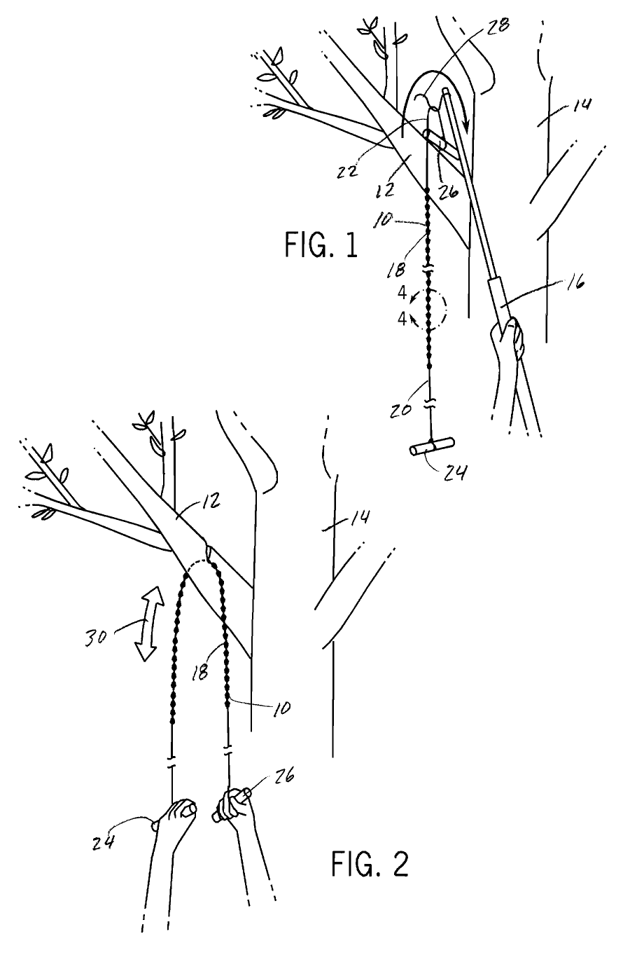

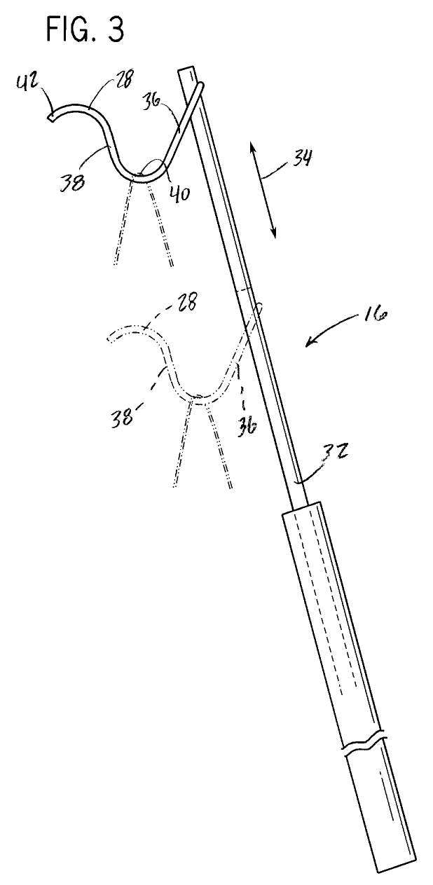

FIG. 1 shows a user placing a flexible tree saw 10 over the limb 12 of a tree 14 using a telescoping tool 16 in accordance with the preferred embodiment of the invention. The flexible saw 10 includes a flexible cutting chain 18, a first rope 20 connected to one end of the flexible cutting chain 18 and a second rope 22 connected to the other end of the flexible cutting chain 18. A first handle 24 is connected to the end of the rope 20, whereas a second handle 26 is connected to the end of the rope 22. The upper end of the telescoping tool 16 includes a rigid hook 28. In practice, the user places one of the ropes 20, 22 over the hook 28 and then lifts the rope 22 and the respective handle 26 over the limb 12 that the user desires to remove. With the lifted handle 26 is placed on the opposite side of the tree limb as handle 24, the user removes the hook. The user then uses the tool 16 and the distal end of the hook 28, as will be described in detail with respect to FIG. 3, to grab the handle 26 on the opposite side of the limb 12 and pull it downward by lowering the telescoping tool 16.

Referring to FIG. 2, with the flexible chain saw 10 properly in place with the flexible cutting chain 18 over the tree limb 12, the user grasps each handle 24, 26, one in each hand. The user then applies a slight downward pressure and pulls the flexible saw 10 in a back and forth motion, as indicated by arrow 30 in FIG. 2. The user continues the back and forth sawing motion until the limb has been removed.

The flexible cutting chain 18, as mentioned, is a jeweler's style chain, e.g., a rolo chain, with stamped sheet steel cutting segments and/or stainless steel links. The preferred length of each cutting segment is about 3/16″ and the preferred length of the steel links is about ⅛″. The rope 20, 22 can be made of any suitable material, for example nylon. The handles, as well, can be made of any suitable material or take on any suitable configuration, including open looped ends of the rope.

Referring to FIG. 3, the tool 16 preferably includes a telescoping pole which can be lengthened or shortened, as is common in the art and as illustrated by arrow 34 in FIG. 3. The pole is preferably made of metal or rigid plastic components, and has a full extended length of at least 20 feet or more. The hook 28 preferably made from a bent steel rod 28, is attached at or near the top of the telescoping pole 32. The hook 28 extends outwardly radially in a serpentine path from the telescoping pole 32. The hook 28 includes a first section 36 that extends angularly downward from the top portion of the pole 32. The hook also includes a second section 38 that extends upwardly substantially in a parallel direction to the telescoping pole 32. The hook 28 defines a cradle 40 between the first angularly downward extending section 36 and the second upwardly extending section 38. As shown in FIGS. 3 and 1, the cradle 40 on the hook is particularly useful for holding the rope 22, 20 portions of the flexible tree saw 10 in order to lift the tree saw 10 into place over a tree limb 12. The distal end 42 of the hook 28 bends slightly downward when the telescoping pole 32 is in a vertical position. The distal end 42 is used to grab or hook the handle, for example handle 26 in FIG. 1, when the handle is raised at the height of the limb 12. The user then pulls the tool 16 downward to reliably lower the handle (e.g. handle 26 in FIG. 1).

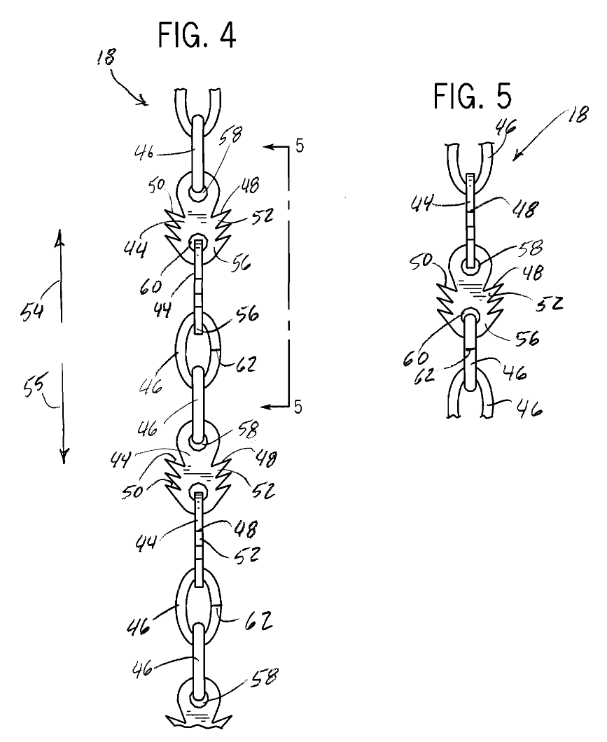

FIGS. 4 and 5 show a portion of the flexible cutting chain 18 in accordance with a first embodiment of the invention. The flexible cutting chain 18 consists of substantially planar cutting segments 44 and oval chain links 46. Each planar cutting segment has a first cutting edge 48 and a second cutting edge 50. The cutting edges 48, 50 shown in FIGS. 4 and 5 have three forwardly facing teeth 52. That is, the teeth 52 face angularly in the cutting direction, which is shown by arrow 54 in FIG. 4. The planar cutting segments 44 include a rounded front portion 56, and otherwise are designed so that there are no sharp edges facing the reverse direction 55. The chain 18 is pulled in the reverse direction 55 without cutting in order to return the chain 18 to a position where it can again be pulled in the forward cutting direction 54 to cut. The use of the rounded reverse profile along with the use of the oval chain links 46 allows the flexible cutting chain 18 to move in the reverse direction 55 reliably and smoothly without binding.

Each planar cutting segment 44 has two link openings 58, 60 stamped through the body. In FIGS. 4 and 5, the planar cutting segments 44 are linked together in pairs so that the cutting edges 48, 50 of one planar segment 44 lie in a plane substantially perpendicular to the cutting edge 48, 50 of the segment 44 to which it is linked, when the chain 18 hangs naturally. Of course, the link between the cutting segments 44 is not rigid so the segments 44 are able to rotate axially relative to one another. In order to link pairs of planar cutting segments 44 together, it is necessary to provide a slot in one of the segments to the opening 58 or 60, slide the other planar cutting segment 44 into place within opening 58 or 60, and then weld or solder the slot in order to ensure sufficient chain strength. On the other hand, the oval chain links 46, preferably made of steel wire, should have sufficient strength without welding or soldering. As is known in the art, the chain links 46 can be bent slightly along the break line 62 in order to attach to adjacent cutting segments 44 or chain links 46.

The chain 18 design in FIGS. 4 and 5 has been found to cut in a particularly effective manner without significant alignment or binding problems. It provides cutting surfaces in all multiple directions, so the initial orientation of the cutting chain 18 on the tree limb is not important for effective sawing. Moreover, as mentioned, the flexible cutting chain 18 is resistant to binding because it is quite easy to pull the chain 18 in the reverse direction 55. In addition, those skilled in the art should note that the construction of the flexible cutting chain 18 is quite simple compared to many of the flexible saw blades in the prior art. For example, the construction of the flexible cutting chain 18 requires no use of rivets or the like, or any machined or bent metal components, or sharpened edges. The flexible cutting chain 18 is also able to bend off plane, which can be helpful in some circumstances, and is especially useful for storage.

Note that the pairs of cutting segments 44 are mounted in the chain 18 so that the teeth 52 all face in the forward direction. This is the preferred configuration for the main portion of the chain. The chain 18 would typically be about two feet to three feet long. Preferably, although not shown in the drawings, at the end of the chain, for example a six-inch span at the end of the chain 18, one of the segments 44 in each pair is reversed. In that way, the user can use the end portion of the flexible cutting chain 18 to cut in a back and forth motion. This is particularly useful, as mentioned, when finishing off the cut through a tree limb. Alternatively, the cutting segments at the end of the chain can have teeth facing straight (i.e., neither forward nor reverse) for this purpose. Such cutting segments can be made from stamped steel links if desirable.

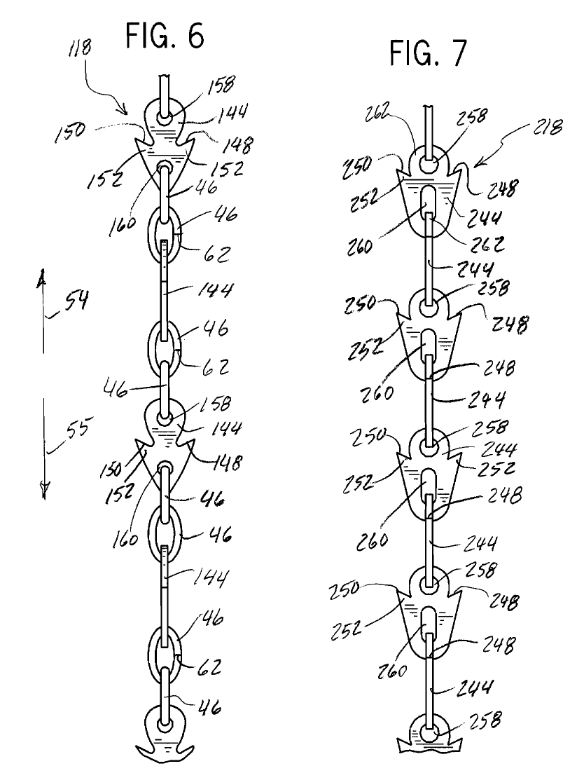

FIG. 6 shows a flexible cutting chain 118 in accordance with another embodiment of the invention. In this embodiment, the planar cutting segments 144 are linked or mounted into the chain 118 individually via chain links 46. The cutting segments 144 are not mounted together in pairs, as in FIG. 5. The planar cutting segments 144 are, however, mounted within the chain 118 so that, when the chain 118 is hanging naturally, the cutting edges 148, 150 of each cutting segment 144 lie in a plane substantially perpendicular to the plane in which the cutting edges 148, 150 of the previous and the subsequent cutting segments 144 lie. In this embodiment, there is no need to cut a slot through the planar cutting segment 144 to the linking openings 158 or 160, and no need to close, weld or solder such a slot. Rather, two chain links 46 are used to connect adjacent cutting segments 144. If one chain link 46 were used, the cutting edges 148, 150 for adjacent cutting segments 144 would lie substantially in the same plane, and the flexible cutting chain 118 would not be nearly as effective as the configuration as shown in FIG. 6. The cutting segments 144 shown in FIG. 6 include only one tooth 152 per cutting edge 148, 150. Again, the cutting segments 144 in the chain 118 are rounded or have no sharp edges exposed when the chain 118 is pulled in the reverse direction 55. The form of the cutting segment 144 with one tooth 152 per cutting edge 148, 150 in FIG. 6 can be used in the chain 18 shown in FIG. 4, and the cutting segment 44 having three teeth 52 per cutting edge 48, 50 in FIG. 4 can be used in the chain 118 in FIG. 6.

FIG. 7 shows a chain 218 in accordance with another embodiment of the invention. In this embodiment, the cutting segments 244 are connected directly to one another without the use of chain links therebetween. Note that the cutting segments 44 each have an opening 258 and a slot 260 stamped along the center line of the segment 244 similar to the linking openings 58, 60 in FIG. 4 and 158, 160 in FIG. 6. As described with respect to the chain 18 in FIG. 4, the cutting segments 244 are linked together by providing or cutting a narrow slot from the outer edge of the cutting segment 244 to the slotted opening 260, or alternatively to the circular opening 258. The adjacent cutting segment 244 is slipped through the slot so that the forward nose 262 resides within the oval opening 260 in the adjacent segment 244. The slot is then soldered or welded together. Again, note that the segments 244 are linked together so that the cutting edges 248, 250 of one segment 244 are substantially perpendicular to the cutting edges 248, 250 of the adjacent cutting segments 244, when the chain 218 hangs naturally. Also, the configuration of the cutting segments 244 again has only one cutting tooth per cutting edge 248, 250 (although more than one tooth may be desirable) and has no sharp edges exposed to the reverse direction 55. It has been found that the chain 218, as shown in FIG. 7, cuts more effectively than those shown in FIGS. 4 and 5 and FIG. 6.

As with the embodiment described in FIG. 4, it is desirable to alternate the direction of the cutting segments 244 in chain 218, FIG. 7, and 144 in chain 118, FIG. 6, for a short span at the end of the chain 218, 118, respectively.

The cutting effectiveness of the chain 218, as well as chains 118 and 18 of the previously described embodiments, can be improved by widening slightly the cutting edges 248, 250 of the link segments 244. Such widened cutting edges would, however, require a separate swaging or upsetting step which would add to the complexity and cost of manufacture. By widening the cutting edges 248, 250, which constitute the lead edges of the cutting chain links in use, it is believed that frictional drag on the remaining flat cutting segments 244 would be reduced.

I claim:

1. A flexible saw comprising:
a flexible cutting chain having a plurality of substantially planar cutting segments each having a first cutting edge on one side of the planar segment and a second cutting edge on the other side of the planar cutting segment, wherein the plurality of planar cutting segments are mounted so that each alternative segment is connected in the chain with a substantially perpendicular orientation with respect to adjacent cutting segments when the chain hangs naturally.

2. A flexible saw as recited in claim 1 further comprising:
a first rope connected to one end of the flexible cutting chain and a first handle connected to the other end of the first rope; and
a second rope connected to the other end of the flexible cutting chain and a second handle connected to the other end of the second rope.

3. A flexible saw as recited in claim 1 wherein the segments of the flexible chain saw blade have teeth facing in one direction for a major portion of the chain so that the chain cuts in one direction only in the main portion.

4. A flexible saw as recited in claim 3 wherein the cutting segments alternate direction in a small portion of the flexible cutting chain near one end of the chain so that teeth on one segment face a first direction and teeth on the next segment face the other direction.

5. A flexible saw as recited in claim 1 wherein the individual chain segments are made of stamped stainless steel.

6. A flexible saw as recited in claim 1 wherein the flexible cutting chain is formed by having two segments connected together in pairs with at least one chain link in between each pair.

7. A flexible saw as recited in claim 6 wherein at least two chain links are connected between each pair of cutting segments.

8. A flexible saw as recited in claim 3 wherein each side of the cutting segment has at least one forwardly facing tooth.

9. A flexible saw as recited in claim 8 wherein each side of the cutting segment has at least three forwardly facing teeth.

10. A flexible saw as recited in claim 1 wherein the chain is formed by having the blades connected together with an oval link between each cutting segment.

11. A flexible saw as recited in claim 1 wherein the flexible cutting chain is formed by having the cutting segments connected together directly in a series.

12. A flexible saw as recited in claim 11 wherein each cutting segment has a circular opening and an oval opening along the center line of the segment for linking together the cutting segments.

13. A flexible saw as recited in claim 1 wherein each planar cutting segment has a length of about 3/16″.

14. A flexible saw as recited in claim 1 wherein the chain comprises planar cutting segments and oval chain links and each planar cutting segment has a length of about 3/16″ and each oval chain link has a length of about ⅛″.

15. A tool for placing a flexible tree cutting chain saw over a tree limb, the flexible tree cutting saw including a flexible cutting chain with a first rope attached to a first end of the flexible cutting chain and a second rope attached to the other end of the flexible cutting chain with a first and second handle attached to the other ends of the first and second ropes, respectively, wherein the tool comprises:
a telescoping pole; and
a radially extending rigid hook mounted at or near the top of the telescoping pole, the hook extending angularly downward when the pole is held vertically to form a first section of the hook, and then bending upward to form a second section of the hook, and finally bending slightly downward again in order to form a third section of the hook as the hook continues to extend radially outward from the telescoping pole;
wherein a cradle formed between the first and sections of the hook is used to hold and lift the flexible tree cutting chain saw into place over a tree limb and the third section is used to grab one of the handles and pull the handle towards the user as the pole is lowered.
